(19) United States
(12) Patent Application Publication
(10) Pub. No.: US 2013/0246341 A1
(43) Pub. Date: Sep. 19, 2013

(54) SYSTEM, METHOD AND COMPUTER PROGRAM PRODUCT FOR MANAGING DATA CREATED IN AN ON-DEMAND SERVICE FROM OTHER DATA, UTILIZING A REPORT

(71) Applicant: SALESFORCE.COM, INC, San Francisco, CA (US)

(72) Inventors: Thomas Joseph Tobin, San Francisco, CA (US); Thomas Kim, San Fracisco, CA (US); Guillaume Le Stum, San Francisco, CA (US); Neelav Rana, Diamond Bar, CA (US)

(73) Assignee: salesforce.com, inc, San Francisco, CA (US)

(21) Appl. No.: 13/873,138

(22) Filed: Apr. 29, 2013

Related U.S. Application Data
(63) Continuation of application No. 12/434,514, filed on May 1, 2009.
(60) Provisional application No. 61/049,703, filed on May 1, 2008.

(51) Int. Cl. G06F 17/30

(52) U.S. Cl. CPC G06F 17/30592
USPC 707/603

(57) ABSTRACT

In accordance with embodiments, there are provided mechanisms and methods for managing data created in an on-demand service, utilizing a report. These mechanisms and methods for managing data created in an on-demand service can enable embodiments to derive data from reports in the form of analytic snapshots. The ability of embodiments to provide management may allow analytical snapshots to be generated and refreshed on a periodic basic such that historical data may be stored.

### CLAIM OF PRIORITY

This application is a continuation of U.S. application Ser. No. 12/434,514, filed May 1, 2009, which claims priority to U.S. Provisional Patent Application No. 61/049,703, filed May 1, 2008, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to database systems, and more particularly to managing data of such database systems,

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request.

There is often a desire to report on the contents of such database systems. To date, reports need to be executed to be displayed. In some cases, a refresh of the report may not be required, but the report execution may be costly. Further, historical data may be expensive to compute and may not always be available.

### BRIEF SUMMARY

In accordance with embodiments, there are provided mechanisms and methods for managing data created in an on-demand service, utilizing a report. These mechanisms and methods for managing data created in an on-demand service can enable embodiments to derive data from reports in the form of analytic snapshots. The ability of embodiments to provide management may allow analytical snapshots to be generated and refreshed on a periodic basic such that historical data may be stored.

In an embodiment and by way of example, a method is provided for managing data created in an on-demand service, utilizing a report. In use, data is periodically derived in an on-demand service from data managed by the on-demand service. Additionally, a command to generate an analytical report is received. Furthermore, the derived data is stored. Still yet, the analytical report is generated based at least in part upon the derived data, the analytical report reflecting a plurality of states in the data managed by the on-demand service.

While the present invention is described with reference to an embodiment in which techniques managing data created in an on-demand service are implemented in an application server providing a front end for a multi-tenant database on-demand service, the present invention is not limited to multi-tenant databases or deployment on application servers. Embodiments may be practiced using other database architectures, i.e., ORACLE®, DB2® and the like without departing from the scope of the embodiments claimed.

Any of the above embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

FIG. 1 shows a method for managing data created in an on-demand service, in accordance with one embodiment.

FIG. 2.1 shows an interface for managing data created in an on-demand service, in accordance with one embodiment.

FIG. 2.2 shows an example of data that is refreshed, in accordance with another embodiment.

FIG. 2.3 shows an example of data that is upserted, in accordance with another embodiment.

FIG. 2.4 shows an example of data that is added to a custom object, in accordance with another embodiment.

FIG. 2.5 shows an example of summary report data output, in accordance with yet another embodiment.

FIG. 3.1 shows an interface for managing data created in an on-demand service, in accordance with another embodiment.

FIG. 3.2 shows an example of allowable type mappings, in accordance with another embodiment.

FIG. 4 illustrates a block diagram of an example of an environment wherein an on-demand database service might be used.

FIG. 5 illustrates a block diagram of an embodiment of elements of FIG. 4 and various possible interconnections between these elements.

### DETAILED DESCRIPTION

### General Overview

Systems and methods are provided for managing data created in an on-demand service.

Currently, reports need to be executed to be displayed. In some cases, a refresh of the report may not be required, but the report execution may be costly. Further, historical data may be expensive to compute and may not always be available.

Thus, mechanisms and methods are provided herein for managing data created in an on-demand service, utilizing a report. These mechanisms and methods for managing data created in an on-demand service can enable embodiments to derive data from reports in the form of analytic snapshots. The ability of embodiments to provide management may allow analytical snapshots to be generated and refreshed on a periodic basic such that historical data may be stored.

Next, mechanisms and methods for managing data created in an on-demand service will be described with reference to exemplary embodiments.

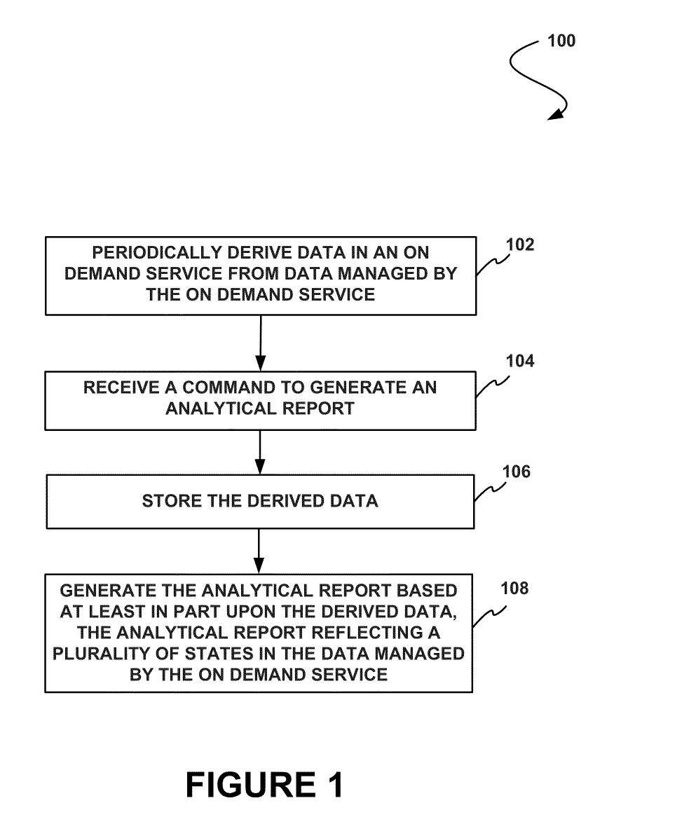

FIG. 1 shows a method 100 for managing data created in an on-demand service, in accordance with one embodiment. As shown, data in an on-demand service is periodically derived from data managed by the on-demand service. See operation 102.

In the context of the present description, an on-demand service refers to any service that relies on a system that is accessible over a network. For example, in one embodiment, the on-demand service may include an on-demand database service. An on-demand database service may include any service that relies on a database system that is accessible over a network.

In one embodiment, the on-demand database service may include a multi-tenant on-demand database service. In the present description, such multi-tenant on-demand database service may include any service that relies on a database system that is accessible over a network, in which various elements of hardware and software of the database system may be shared by one or more customers. For instance, a given application server may simultaneously process requests for a great number of customers, and a given database table may store rows for a potentially much greater number of customers.

In addition to periodically deriving data in the on-demand service, a command to generate an analytical report is received. See operation 104. In one embodiment, the command to generate the analytical report may be received from a user of the on-demand database service.

Furthermore, the derived data is stored, See operation 106. Additionally, the analytical report is prepared based at least in part upon the derived data, the analytical report reflecting a plurality of states in the data managed by the on-demand service. See operation 108,

In one embodiment, generating the analytical report may include appending the derived data to at least a portion of the data managed by the on-demand service. In this case, appending the derived data to the data managed by the on-demand service may include appending the derived data to at least a portion of previously derived data. The previously derived data may include any data derived in a previous operation.

In another embodiment, generating the analytical report may include replacing at least a portion of the data managed by the on-demand service with the derived data. As an option, replacing the data managed by the derived data may include replacing at least a portion of previously derived data with the derived data. As another option, replacing the data managed by the derived data may include replacing at least a portion of any existing data with the derived data.

In still another embodiment, generating the analytical report may include adding the derived data to the data managed with the on-demand service. In this case, the data managed with the on-demand service may include data derived from a previous operation.

It should be noted that, in one embodiment, a user of the on-demand service may be capable of defining data to be derived. Furthermore, in various embodiments, deriving the data may include different operations.

For example, in one embodiment, deriving the data may include creating the derived data utilizing a subset of rows and fields associated with at least a portion of the data managed by the on-demand service. In this case, the derived data may include any portion of the data managed by the on-demand service. This may include a portion of previously derived data or any other existing data. For example, the derived data may include select rows, columns, fields, and/or any other portion of the data.

In another embodiment, deriving the data may include modifying a form of at least a portion of the data managed by the on-demand service, For example, a portion of the existing data (e.g. previously derived data or other data, etc.) may be modified from a first form or a first format to a second form or second format, as part of deriving the data. Additionally, deriving the data may further include aggregating at least a portion of the data managed by the on-demand service.

In addition to generating the analytical report, as an option, the analytical report may be displayed. For example, the analytical report may be displayed to a user of the on-demand service. In one embodiment, the user may view, access, modify, and/or evaluate information associated with the analytical report.

For example, information associated with the analytical report may be capable of being utilized as an input for a data transformation. As another option, information associated with the analytical report may be capable of being utilized for subsequent storage of data. Still yet, in one embodiment, the analytical report may be processed. As an option, an output of the processing of the analytical report may be batched into chunks of data.

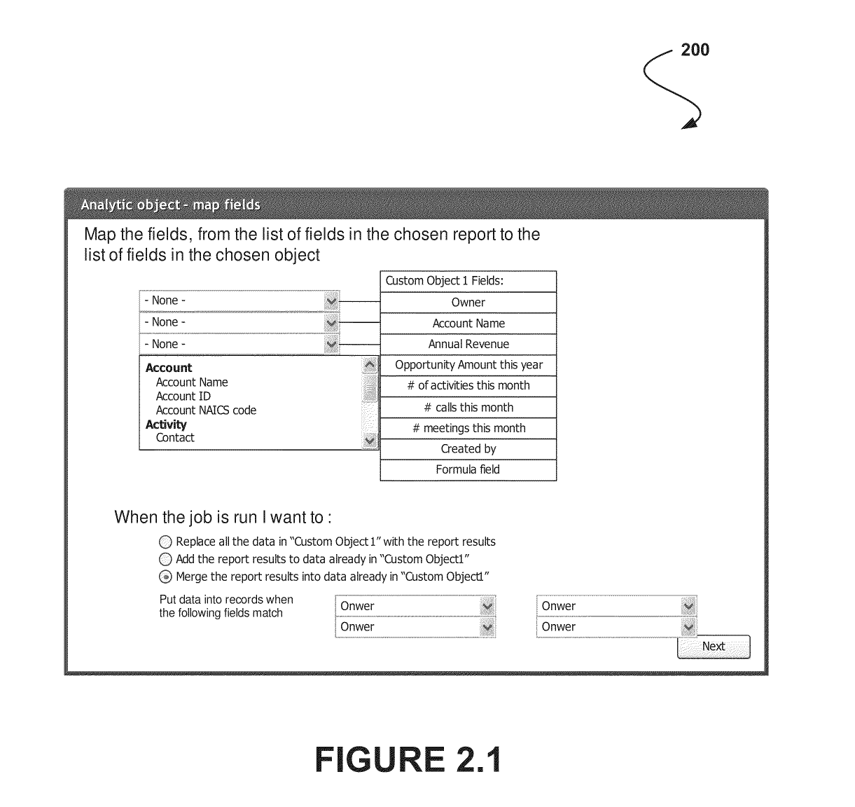

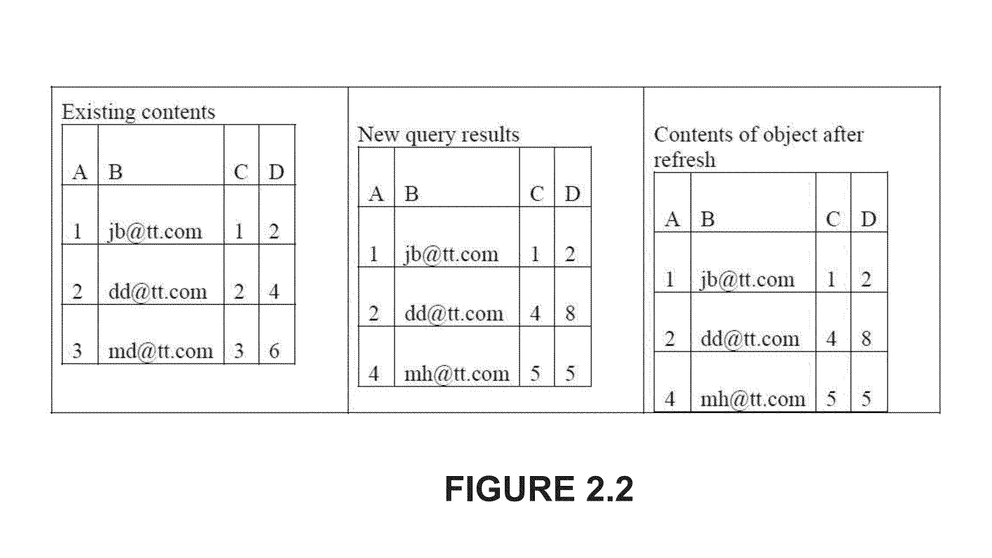

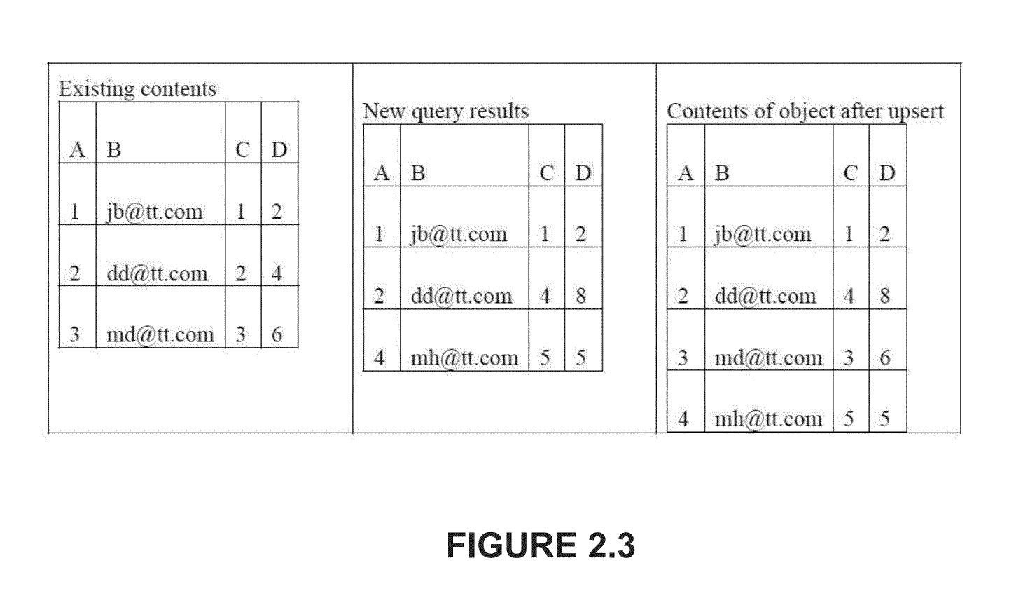

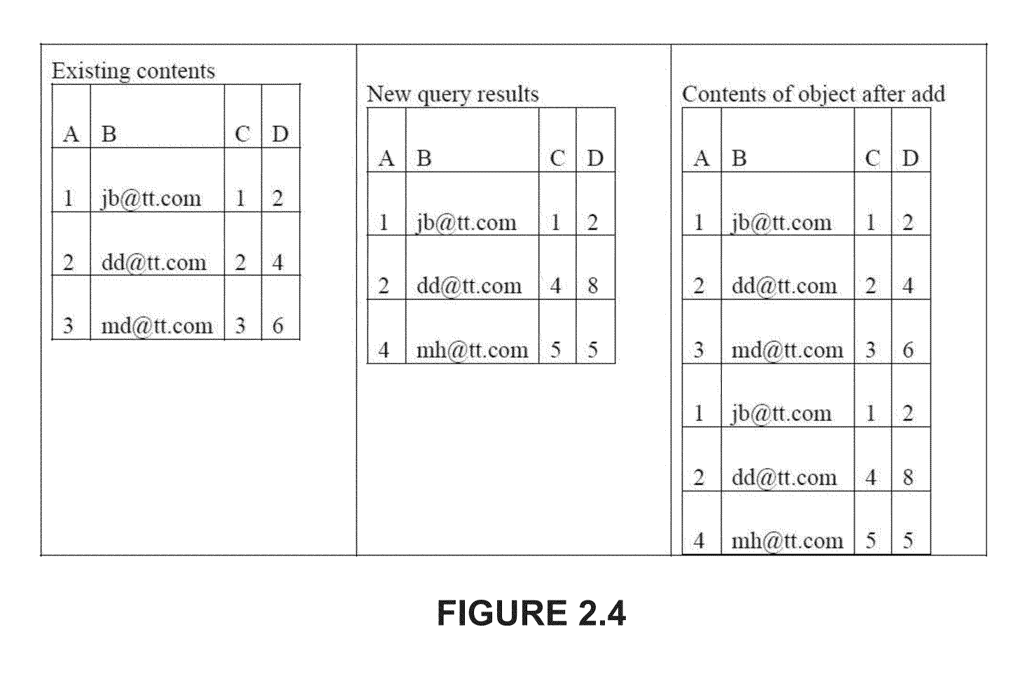

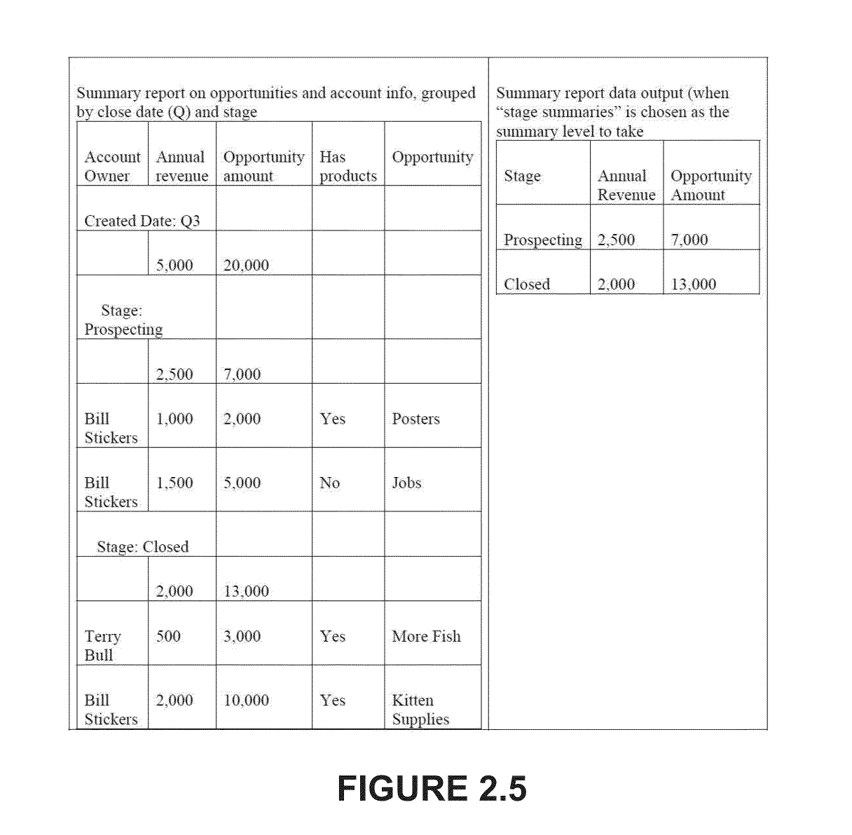

FIG. 2.1 shows an interface 200 for managing data created in an on-demand service, in accordance with one embodiment. As an option, the present interface 200 may be utilized in the context of the functionality of FIG. 1. Of course, however, the interface 200 may be utilized in any desired environment. The aforementioned definitions may apply during the present description.

In operation, the interface 200 may be utilized to map fields in a report to an object. In this case, the object may refer to any data managed by an on-demand service. For example, in one embodiment, the object may include a table. Additionally, the report may include derived data. Further, the interface 200 may be utilized to select a technique for generating a report. For example, the interface may present a user with the option to replace all of the data in a selected object with results of an executed report, add the report results to data already in the object, or merge the report results into data already in the object.

Furthermore, using the interface 200 or another interface, a command to produce an analytical report may be sent by a user. The analytical report may then be prepared based at least in part upon derived data so that the analytical report reflects a plurality of states in the data managed by the on demand service. In this way, data created in an on-demand database service may be managed via a report.

For example, in some cases, reports may need to be executed to be displayed. In some cases, a refresh may not be required but report execution may still be costly. Additionally, historical data may not only be expensive to compute, but may not always be available. Deriving data from reports in the form of analytic snapshots may allow snapshots to be generated and refreshed on a periodic basic such that historical data may be stored. In addition, efficient reports may be built on top of these snapshots.

In operation, reports (e.g. tabular or summary reports, etc.) may be used to generate data which may then be inserted into custom objects. In one embodiment, execution may be scheduled using a scheduler. Additionally, as an option. new entities may be introduced to store analytic snapshot definitions (e.g. a source report, a target custom object, a field mapping, etc.) and run history information.

In various embodiments, the analytical source reports may be tabular or summary reports. In one embodiment, source reports may be created specially for and dedicated to analytic snapshots. As an option, report deletion may be prevented when it is referenced by an analytic snapshot. Furthermore, in some cases, modifying a report may eliminate analytic snapshots referencing it.

As noted above, in one embodiment, custom objects may be used as a destination for derived data. In some cases, several analytic snapshots may be used to update the same objects. In these cases, because several analytic snapshots may be updating the same objects, custom object definitions may not be created automatically in association with an analytic job.

As an option, a custom object may be created specifically for and dedicated to analytic snapshots. Furthermore, as an option, custom object deletion may be prevented when it is referenced by an analytic snapshot.

In one embodiment, field mapping may be checked when created/modified and at runtime before executing the analytic snapshot. As an option, a report column may be inserted into a field with an underlying column of the same type or of type text as a default. In one embodiment, only dynamic pick lists may be supported as a target enumerator. In this case, unknown new values may be inserted as inactive values and may be displayed and used in a report filter lists.

At any given time, a single analytic snapshot may be running for any custom object. The analytic snapshot may be scheduled or manually initiated. In one embodiment, an organization lock of an analytic snapshot type with a subtype set to a target custom object definition identifier row may be used to prevent concurrent executions. Additionally, in one embodiment, create, read, update, and delete (CRUD) functions may be allowed to be performed and may not be prevented while executing a report.

In one embodiment, analytic report snapshot execution may take place in a single transaction. At the end of the transaction, all processed rows may be either inserted in a target object or accounted for in a persisted snapshot run history of row errors.

As an option, an append mode may be utilized to append derived data to existing data, as noted above. In append mode, custom objects may be inserted using one or more APIs. As an option, reports may be streamed and processed in chunks (e.g. chunks of 100 rows, 200 rows, etc.). In this case, a bulk API may retry each row individually in the case there is any error, a failed row may cause, at a maximum, the number of the rows in the chunk to be individually retried. It should be noted that, in one embodiment, the derived data may include metadata associated with an execution date, a name of a report, and/or various other information.

In one embodiment, in order to limit the memory impact of processing a large number of entity objects in a single transaction (e.g. due to other entity objects read as a side effect and cached in the transaction, etc.), certain features may be disabled when inserting derived data. For example, any APEX triggers, workflow functions, validation functions (e.g. spanning formulas, etc,), etc, may be disabled.

Also, insertion into master objects may be supported, which may prevent side effects from rollup summary fields processing (e.g. APEX triggered in parent fields, etc.). In addition to the append mode, an update mode and replacement mode may be utilized. In this case, the update mode may allow for an object or a portion of the object to be updated with the data derived from the reports. Furthermore, in the update mode, a custom object external identifier may be used to store a concatenated composite key of the source rows.

The replacement mode may allow for an object or a portion of an object to be replaced by data derived from the reports. For example, in replacement mode, the target object may be bulk deleted.

Additionally, in one embodiment, a test mode may be available to a user. In this case, a user may manually run an analytic snapshot. At the end of the execution, a rollback may occur and any error may be displayed. As an option, the user may limit the number of processed rows for shorter trial/error cycles.

Implementing the test mode may allow for better handling of analytic snapshot dependencies which may cause snapshots to fail. In this way, the most common modifications which may cause an existing analytic snapshot to fail may be detected and prevented beforehand. In various embodiments, these modifications may include custom field modifications, report modifications, report deletions, and access right changes (e.g. source report and target custom object versus running user, etc.).

In one embodiment, report data and metadata may be configured to allow par reruns while preserving data consistency and avoiding snapshot data loss. As an option, only failed rows may be rerun.

Further, the state of object row may include a pending state, a confirmed state, an appended state, a replace or update state, and various other states. In the case of a replace or update state, a copy of the original data may be kept until a snapshot run is confirmed. Additionally, a user may have the ability to cancel a snapshot run (e.g. if source report needs changes, etc.).

In one embodiment, handling the state of a target object may require either custom object enhancements or dedicated target data structure as analytic snapshot specific metadata. Further, indexing on target custom objects may be required for efficient processing. With improved error recovery, it may be possible to have one transaction per chunk and process more rows.

In one embodiment, processing a report may be distributed among one of a plurality backend servers associated with an on-demand database service. As an option, analytic snapshots of multiple tenants may be processed in parallel. In this case, processing may occur within the context of a specific “running user,” which may be specified as part of the snapshot definition.

The analytical source report may be executed and its output data may be processed on the fly. In one embodiment, a report output may be batched in chunks of rows (e.g. 100 rows, 200 rows, etc.). By batching, only a fixed amount of memory is required where the amount is determined by chunk size instead of total number of rows in a report. As an option, each chunk may be processed in a single database call for efficiency purposes.

In the case that there are errors in a chunk, each row may be retried individually. In this case, as much valid data as possible may be inserted. Additionally, more information may be retrieved about failed rows. Statistically, most chunks are error free. Thus, chunking allows for efficient data insertion while still inserting as many valid rows as possible.

In one embodiment, data may be converted from report columns to target object fields according to tenant specific metadata. This may include snapshot fields mapping definitions (e.g. metadata such as snapshot execution timestamp, name, and running user, etc.), source report column and target object field data types, and currency.

When data is being refreshed or updated in an object, all records from the object may be emptied, the query may be executed, and one record may be created for each row returned on the screen (e.g. for aggregations, the detail rows may not inserted, etc.). FIG. 2.2 shows an example implementation of this, in accordance with one embodiment.

When upserting data, a definition of the comparable identifiers may be present for records. Optionally, these identifying columns may be used to match records, and the other mapped columns may be updated.

For example, in FIG. 2.3, the identifying columns are A and B. In this example, C and D are measure columns that may be calculated in the report.

If the data is added to the custom object, no matching data may be performed, and the data may include all data ever placed into the object. This may be useful when the date of the data is also inserted. FIG. 2.4 shows an example of adding data to a custom object, in accordance with one embodiment.

When using a summary report as a source, a user may need to select the level of aggregation at which the totals are taken. This may be useful to convert an n-dimensional hierarchy of a summary report into a I-dimensional tabular dataset ready to be inserted. FIG. 2.5 shows an example of a summary report on opportunities and account information, grouped by close date (Q) and stage, and a summary report data output, when “stage summaries” is chosen as the summary level to take, in accordance with one embodiment.

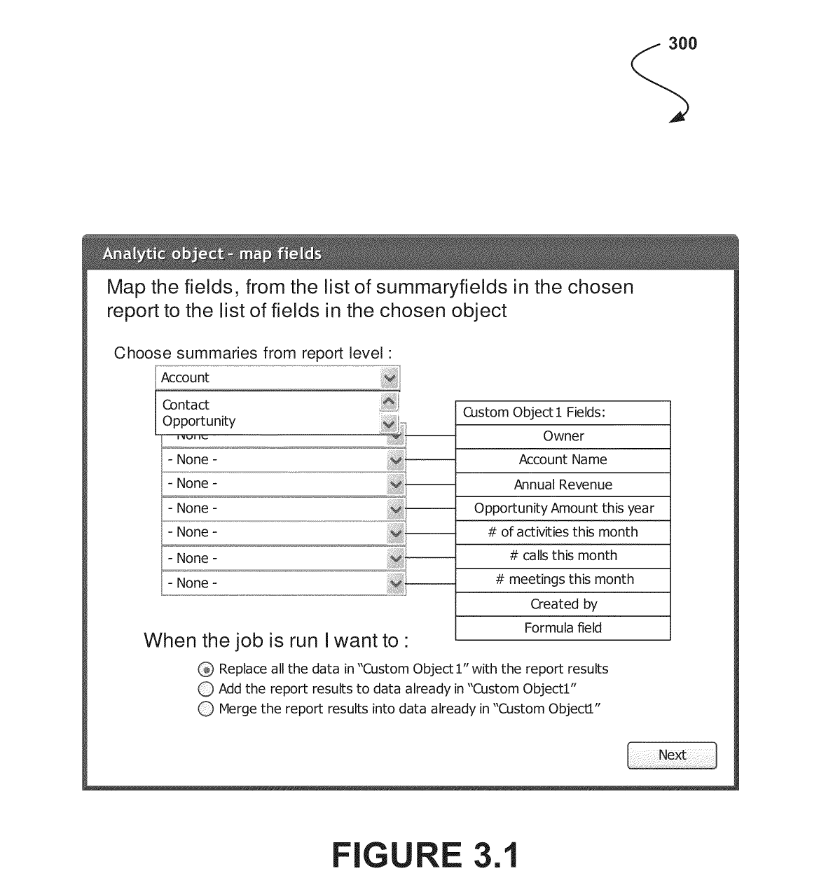

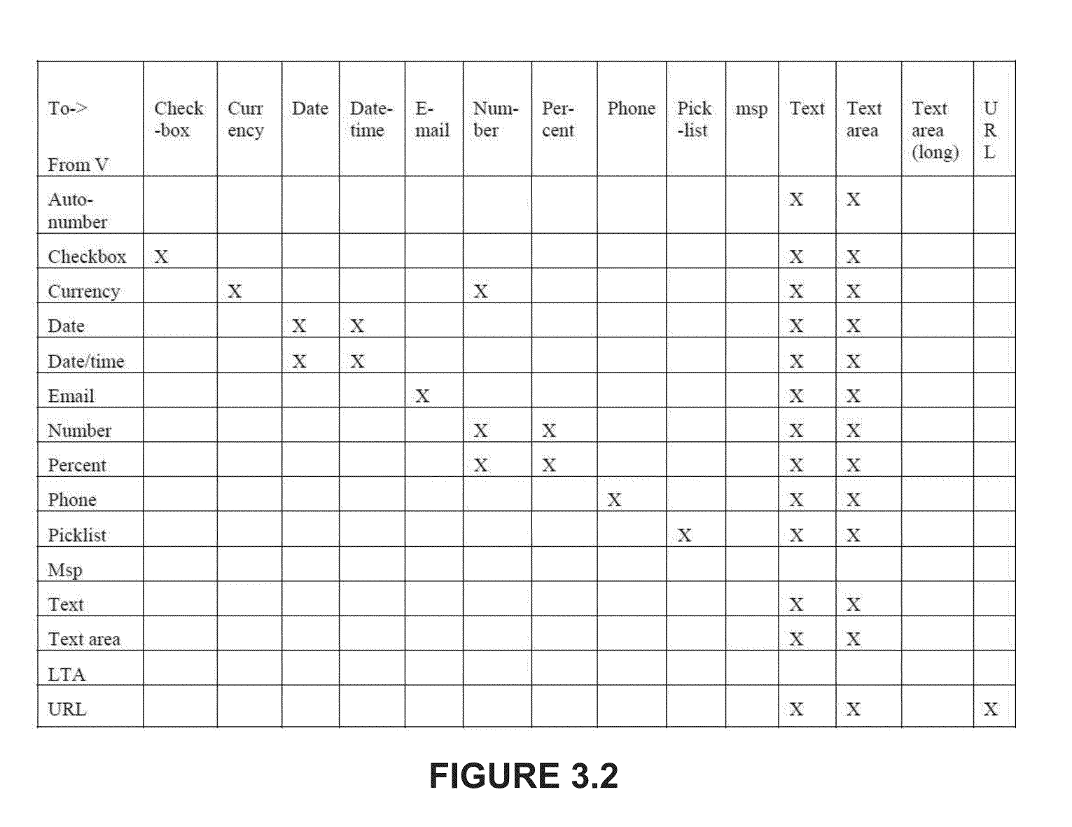

FIG. 3.1 shows an interface 300 for managing data created in an on-demand service, in accordance with another embodiment. As an option, the present interface 300 may be utilized in the context of the functionality of the previous figures. Of course, however, the interface 300 may be utilized in any desired environment. Again, the aforementioned definitions may apply during the present description.

In operation, the interface 300 may be utilized to map fields of a report to a list of fields in an object. The interface 300 may also be utilized to select a technique for generating a report. For example, the interface may present a user with the option to replace all of the data in a selected object with results of an executed report, add the report results to data already in the object, or merge the report results into data already in the object.

It should be noted that, in various embodiments, many different mappings may be supported. For example, FIG. 3.2 illustrates type mappings that may be allowed, in accordance with one embodiment.

### System Overview

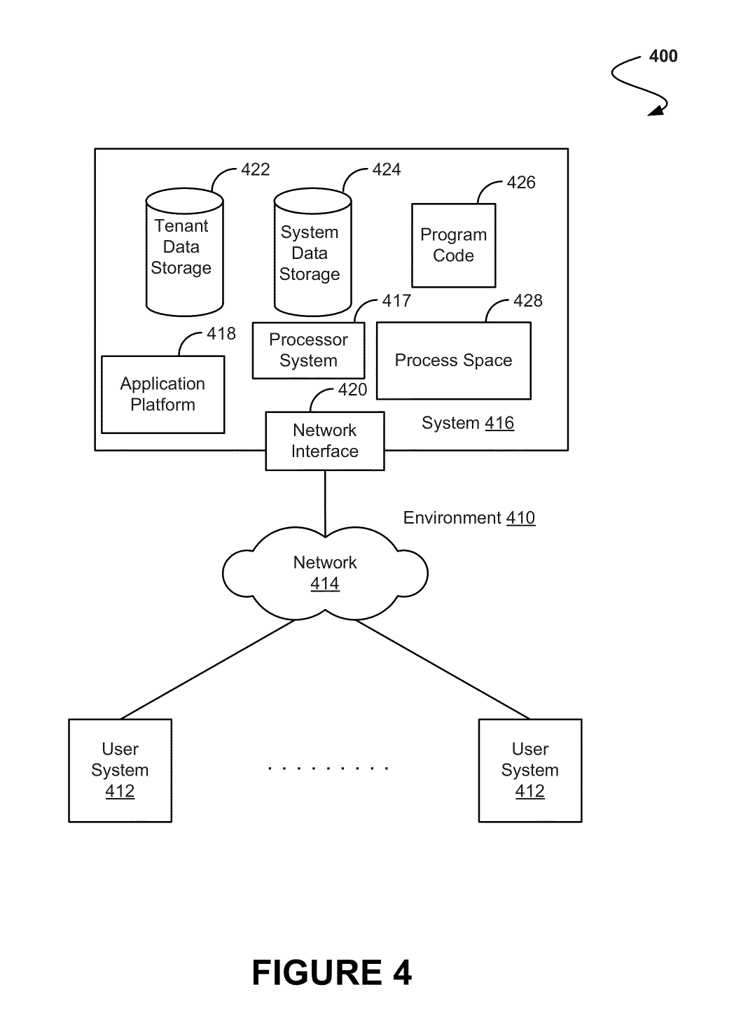

FIG. 4 illustrates a block diagram of an environment 410 wherein an on-demand database service might be used. As an option, any of the previously described embodiments of the foregoing figures may or may not be implemented in the context of the environment 410. Environment 410 may include user systems 412, network 414, system 416, processor system 417, application platform 418, network interface 420, tenant data storage 422, system data storage 424, program code 426, and process space 428. In other embodiments, environment 410 may not have all of the components listed and/or may have other elements instead of, or in addition to, those listed above.

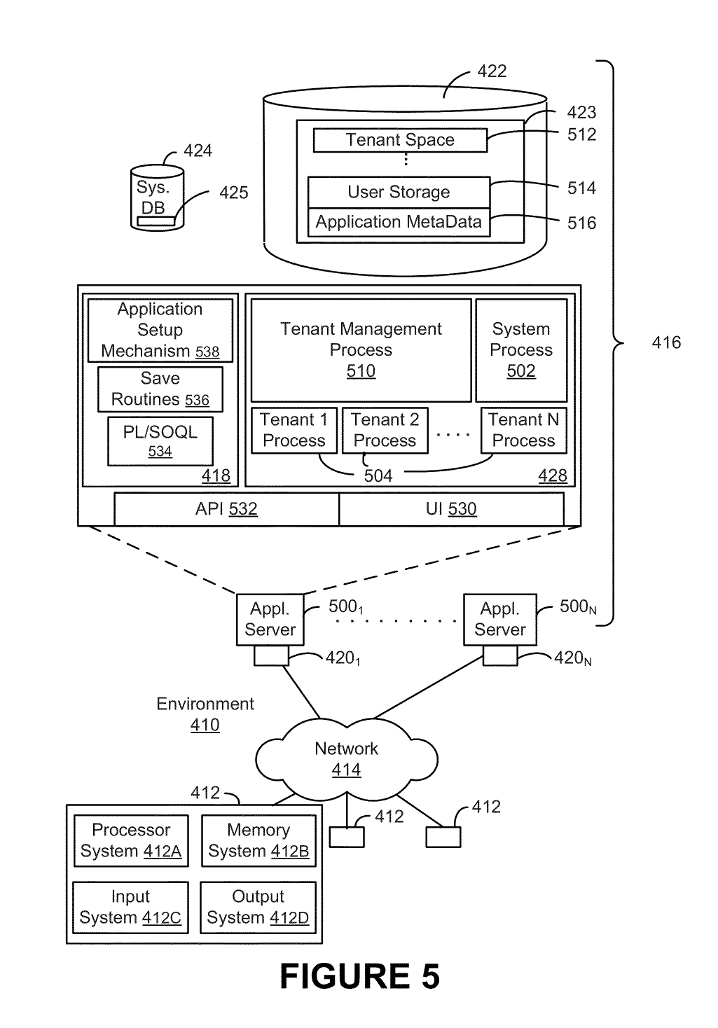

Environment 410 is an environment in which an on-demand database service exists. User system 412 may be any machine or system that is used by a user to access a database user system. For example, any of user systems 412 can be a handheld computing device, a mobile phone, a laptop computer, a work station, and/or a network of computing devices. As illustrated in FIG. 4 (and in more detail in FIG. 5) user systems 412 might interact via a network with an on-demand database service, which is system 416.

An on-demand database service, such as system 416, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 416” and “system 416” will be used interchangeably herein. A database image may include one or more database objects. A relational database management system (RDMS) or the equivalent may execute storage and retrieval of information against the database object(s). Application platform 418 may be a framework that allows the applications of system 416 to run, such as the hardware and/or software, e.g., the operating system. In an embodiment, on-demand database service 416 may include an application platform 418 that enables creation, managing and executing one or more applications developed by the provider of the on-demand database service, users accessing the on-demand database service via user systems 412, or third party application developers accessing the on-demand database service via user systems 412.

The users of user systems 412 may differ in their respective capacities, and the capacity of a particular user system 412 might be entirely determined by permissions (permission levels) for the current user. For example, where a salesperson is using a particular user system 412 to interact with system 416, that user system has the capacities allotted to that salesperson. However, while an administrator is using that user system to interact with system 416, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 414 is any network or combination of networks of devices that communicate with one another. For example, network 414 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the present invention might use are not no limited, although TCP/IP is a frequently implemented protocol.

User systems 412 might communicate with system 416 using TCP/IP and, at a higher network level, use other common Internet protocols to communicate, such as HTTP, FTP, AFS, WAP, etc. In an example where HTTP is used, user system 412 might include an HTTP client commonly referred to as a “browser” for sending and receiving HTTP messages to and from an HTTP server at system 416. Such an HTTP server might be implemented as the sole network interface between system 416 and network 414, but other techniques might be used as well or instead. In some implementations, the interface between system 416 and network 414 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 416, shown in FIG. 4, implements a web-based customer relationship management (CRM) system. For example, in one embodiment, system 416 includes application servers configured to implement and execute CRM software applications as well as provide related data, code, forms, webpages and other information to and from user systems 412 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 416 implements applications other than, or in addition to, a CRM application. For example, system 416 may provide tenant access to multiple hosted (standard and custom) applications, including a CRM application. User (or third party developer) applications, which may or may not include CRM, may be supported by the application platform 418, which manages creation, storage of the applications into one or more database objects and executing of the applications in a virtual machine in the process space of the system 416.

One arrangement for elements of system 416 is shown in FIG. 5, including a network interface 420, application platform 418, tenant data storage 422 for tenant data 423, system data storage 424 for system data accessible to system 416 and possibly multiple tenants, program code 426 for implementing various functions of system 416, and a process space 428 for executing MTS system processes and tenant-specific processes, such as running applications as part of an application hosting service. Additional processes that may execute on system 416 include database indexing processes.

Several elements in the system shown in FIG. 4 include conventional, well-known elements that are explained only briefly here. For example, each user system 412 could include a desktop personal computer, workstation, laptop, PDA, cell phone, or any wireless access protocol (WAP) enabled device or any other computing device capable of interfacing directly or indirectly to the Internet or other network connection. User system 412 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g. subscriber of the multi-tenant database system) of user system 412 to access, process and view information, pages and applications available to it from system 416 over network 414. Each user system 412 also typically includes one or more user interface devices, such as a keyboard, a mouse, trackball, touch pad, touch screen, pen or the like, for interacting with a graphical user interface (GUI) provided by the browser on a display (e.g. a monitor screen, LCD display, etc.) in conjunction with pages, forms, applications and other information provided by system 416 or other systems or servers. For example, the user interface device can be used to access data and applications hosted by system 416, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, extranet, a virtual private network (VPN), a non-TCP/IP based network, any LAN or WAN or the like.

According to one embodiment, each user system 412 and all of its components are operator configurable using applications, such as a browser, including computer code run using a central processing unit such as an Intel Pentium® processor or the like. Similarly, system 416 (and additional instances of an MTS, where more than one is present) and all of their components might be operator configurable using application(s) including computer code to run using a central processing unit such as processor system 417 of FIG. 4, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 416 to intercommunicate and to process webpages, applications and other data and media content as described herein are preferably downloaded and stored on a hard disk, but the entire program code, or portions thereof, may also he stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g. extranet, VPN, LAN, etc.) using any communication medium and protocols (e.g. TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C. C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 416 is configured to provide webpages, forms, applications, data and media content to user (client) systems 412 to support the access by user systems 412 as tenants of system 416. As such, system 416 provides security mechanisms to keep each tenant's data separate unless the data is shared. If more than one MTS is used, they may be located in close proximity to one another/e.g. in a server farm located in a single building or campus), or they may be distributed at locations remote from one another (e.g. one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g. (OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 5 also illustrates environment 410. However, in FIG. 5 elements of system 416 and various interconnections in an embodiment are further illustrated. FIG. 5 shows that user system 412 may include processor system 412A, memory system 412B, input system 412C, and output system 412D. FIG. 5 shows network 414 and system 416. FIG. 5 also shows that system 416 may include tenant data storage 422, tenant data 423, system data storage 424, system data 425, User Interface (UI) 530, Application Program Interface (API) 532, PL/SOQL, 534, save routines 536, application setup mechanism 538, applications servers 500₁-500_{N}, system process space 502, tenant process spaces 504, tenant management process space 510, tenant storage area 512, user storage 514, and application metadata 516. In other embodiments, environment 410 may not have the same elements as those listed above and/or may have other elements instead of, or in addition to, those listed above.

User system 412, network 414, system 416, tenant data storage 422, and system data storage 424 were discussed above in FIG. 4. Regarding user system 412, processor system 412A may be any combination of one or more processors. Memory system 412B may be any combination of one or more memory devices, short term, and/or long term memory. Input system 412C may be any combination of input devices, such as one or more keyboards, mice, trackballs, scanners, cameras, and/or interfaces to networks. Output system 412D may be any combination of output devices, such as one or more monitors, printers, and/or interfaces to networks. As shown by FIG. 5, system 416 may include a network interface 420 (of FIG. 4) implemented as a set of HTTP application servers 500, an application platform 418, tenant data storage 422, and system data storage 424. Also shown is system process space 502, including individual tenant process spaces 504 and a tenant management process space 510. Each application server 500 may be configured to tenant data storage 422 and the tenant data 423 therein, and system data storage 424 and the system data 425 therein to serve requests of user systems 412. The tenant data 423 might be divided into individual tenant storage areas 512, which can be either a physical arrangement and/or a logical arrangement of data. Within each tenant storage area 512, user storage 514 and application metadata 516 might be similarly allocated for each user. For example, a copy of a user's most recently used (MRU) items might be stored to user storage 514. Similarly, a copy of MRU items for an entire organization that is a tenant might be stored to tenant storage area 512. A UI 530 provides a user interface and an API 532 provides an application programmer interface to system 416 resident processes to users and/or developers at user systems 412. The tenant data and the system data may be stored in various databases, such as one or more Oracle™ databases.

Application platform 418 includes an application setup mechanism 538 that supports application developers' creation and management of applications, which may be saved as metadata into tenant data storage 422 by save routines 536 for execution by subscribers as one or more tenant process spaces 504 managed by tenant management process 510 for example. Invocations to such applications may be coded using PL/SOQL 534 that provides a programming language style interface extension to API 532. A detailed description of some PL/SOQL language embodiments is discussed in commonly owned U.S. Provisional Patent Application 60/828,192 entitled, “PROGRAMMING LANGUAGE METHOD AND SYSTEM FOR EXTENDING APIS TO EXECUTE IN CONJUNCTION WITH DATABASE APIS,” by Craig Weissman, filed Oct. 4, 2006, which is incorporated in its entirety herein for all purposes. Invocations to applications may be detected by one or more system processes, which manage retrieving application metadata 516 for the subscriber making the invocation and executing the metadata as an application in a virtual machine.

Each application server 500 may be communicably coupled to database systems, e.g., having access to system data 425 and tenant data 423, via a different network connection. For example, one application server 500₁ might be coupled via the network 414 (e.g., the Internet), another application server 500_{N-1} might be coupled via a direct network link, and another application server 500_{N} might be coupled by yet a different network connection. Transfer Control Protocol and Internet Protocol (TCP/IP) are typical protocols for communicating between application servers 500 and the database system. However, it will be apparent to one skilled in the art that other transport protocols may be used to optimize the system depending on the network interconnect used.

In certain embodiments, each application server 500 is configured to handle requests for any user associated with any organization that is a tenant. Because it is desirable to be able to add and remove application servers from the server pool at any time for any reason, there is preferably no server affinity for a user and/or organization to a specific application server 500. In one embodiment, therefore, an interface system implementing aloud balancing function (e.g., an F5 Big-IP load balancer) is communicably coupled between the application servers 500 and the user systems 412 to distribute requests to the application servers 500. In one embodiment, the load balancer uses a least connections algorithm to route user requests to the application servers 500. Other examples of load balancing algorithms, such as round robin and observed response time, also can be used. For example, in certain embodiments, three consecutive requests from the same user could hit three different application servers 500, and three requests from different users could hit the same application server 500. In this manner, system 416 is multi-tenant, wherein system 416 handles storage of, and access to, different objects, data and applications across disparate users and organizations.

As an example of storage, one tenant might be a company that employs a sales force where each salesperson uses system 416 to manage their sales process. Thus, a user might maintain contact data, leads data, customer follow-up data, performance data, goals and progress data, etc., all applicable to that user's personal sales process (e.g., in tenant data storage 422). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 416 that are allocated at the tenant level while other data structures might be managed at the user level, Because an MTS might support multiple tenants including possible competitors, the MTS should have security protocols that keep data, applications, and application use separate, Also, because many tenants may opt for access to an MTS rather than maintain their own system, redundancy, up-time, and backup are additional functions that may be implemented in the MTS. In addition to user-specific data and tenant-specific data, system 416 might also maintain system level data usable by multiple tenants or other data. Such system level data might include industry reports, news, postings, and the like that are sharable among tenants.

In certain embodiments, user systems 412 (which may be client systems) communicate with application servers 500 to request and update system-level and tenant-level data from system 416 that may require sending one or more queries to tenant data storage 422 and/or system data storage 424. System 416 (e.g., an application server 500 in system 416) automatically generates one or more SQL statements (e.g., one or more SQL queries) that are designed to access the desired information. System data storage 424 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to the present invention. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard. entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom. index fields. U.S. patent application Ser. No. 10/817,161, filed Apr. 2, 2004, entitled “CUSTOM ENTITIES AND FIELDS IN A MULTI-TENANT DATABASE SYSTEM,” which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

It should be noted that any of the different embodiments described herein may or may not be equipped with any one or more of the features set forth in one or more of the following published applications: US2003/0233404, titled “OFFLINE SIMULATION OF ONLINE SESSION BETWEEN CLIENT AND SERVER,” filed Nov. 4, 2002; US2004/0210909, titled “JAVA OBJECT CACHE SERVER FOR DATABASES,” filed Apr. 17, 2003, now issued U.S. Pat. No. 7,209,929; US2005/0065925, titled “QUERY OPTIMIZATION IN A MULTI-TENANT DATABASE SYSTEM,” filed Sep. 23, 2003; US2005/0223022, titled “CUSTOM ENTITIES AND FIELDS IN A MULTI-TENANT DATABASE SYSTEM,” filed Apr. 2, 2004; US2005/0283478, titled “SOAP-BASED WEB SERVICES IN A MULTI-TENANT DATABASE SYSTEM,” filed Jun. 16, 2004; and/or US2006/0206834, titled “SYSTEMS AND METHODS FOR IMPLEMENTING MULTI-APPLICATION TABS AND TAB SETS,” filed Mar. 8, 2005; which are each incorporated herein by reference in their entirety for all purposes.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method, comprising:
periodically deriving data in an on-demand service from data managed by the on-demand service;
receiving a command to generate an analytical report;
storing the derived data; and
generating the analytical report based at least in part upon the derived data, the analytical report reflecting a plurality of states in the data managed by the on-demand service.

2. The method of claim 1, wherein generating the analytical report includes appending the derived data to at least a portion of the data managed by the on-demand service.

3. The method of claim 2, wherein appending the derived data to the at least a portion of the data managed by the on-demand service includes appending the derived data to at least a portion of previously derived data.

4. The method of claim 1, wherein generating the analytical report includes replacing at least a portion of the data managed by the on-demand service with the derived data.

5. The method of claim 4, wherein replacing the at least a portion of the data managed by the derived data includes replacing at least a portion of previously derived data with the derived data.

6. The method of claim 1, wherein generating the analytical report includes adding the derived data to the data managed by the on-demand service.

7. The method of claim 6, wherein the data managed by the on--demand service includes data derived from a previous operation.

8. The method of claim 1, wherein deriving the data includes creating the derived data utilizing a subset of rows and fields associated with at least a portion of the data managed by the on-demand service.

9. The method of claim 1, wherein deriving the data includes modifying a form of at least a portion of the data managed by the on-demand service.

10. The method of claim 9, wherein deriving the data further includes aggregating at least a portion of the data managed by the on-demand service.

11. The method of claim 1, wherein a user of the on-demand service is capable of defining data to be derived.

12. The method of claim 1, wherein the command to generate the analytical report is received from a user of the on-demand service.

13. The method of claim 1, further comprising displaying the analytical report.

14. The method of claim 1, wherein information associated with the analytical report is capable of being utilized as an input for a data transformation.

15. The method of claim 1, further comprising processing the analytical report.

16. The method of claim 1, wherein the on-demand service includes a multi-tenant on-demand database service.

17. A machine-readable medium carrying one or more sequences of instructions which, when executed by one or more processors, cause the one or more processors to carry out the steps of:
periodically deriving data in an on-demand service from data managed by the on-demand service;
receiving a command to generate an analytical report;
storing the derived data; and
generating the analytical report based at least in part upon the derived data, the analytical report reflecting a plurality of states in the data managed by the on-demand service.

18. An apparatus, comprising:
a processor; and
one or more stored sequences of instructions which, when executed by the processor, cause the processor to carry out the steps of:
periodically deriving data in an on-demand service from data managed by the on-demand service;
receiving a command to generate an analytical report;
storing the derived data and
generating the analytical report based at least in part upon the derived data, the analytical report reflecting a plurality of states in the data managed by the on-demand service.

19. A method for transmitting code for use in a multi-tenant database system on a transmission medium, the method comprising:
transmitting code for periodically deriving data in an on-demand service from data managed by the on-demand service;
transmitting code for receiving a command to generate an analytical report;
transmitting code for storing the derived data; and
transmitting code for generating the analytical report based at least in part upon the derived data, the analytical report reflecting a plurality of states in the data managed by the on-demand service.
